(19) United States
(12) Patent Application Publication
(10) Pub. No.: US 2026/0059373 A1
(43) Pub. Date: Feb. 26, 2026

(54) METHODS AND SYSTEMS FOR PERFORMINGENERGY-AWARE SERVICE DELIVERY IN WIRELESS COMMUNICATION NETWORKS

(71) Applicant: INDIAN INSTITUTE OF TECHNOLOGY, BOMBAY, Mumbai (IN)

(72) Inventors: Rashmi KAMRAN, Mumbai (IN); Pranav Kumar JHA, Mumbai (IN); Prasanna S. CHAPORKAR, Mumbai (IN); Abhay KARANDIKAR, Mumbai (IN); Shwetha KIRAN, Mumbai (IN)

(73) Assignee: INDIAN INSTITUTE OF TECHNOLOGY, BOMBAY, Mumbai (IN)

(21) Appl. No.: 19/373,167

(22) Filed: Oct. 29, 2025

(30) Foreign Application Priority Data
May 29, 2025 (IN) 202521052097

(51) Int. Cl. H04W 28/02; H04W 28/24

(52) U.S. Cl. CPC H04W 28/0221; H04W 28/24

(57) ABSTRACT

Embodiments disclosed herein relate to methods and systems for providing energy-aware service delivery in wireless communication networks by adjusting Quality of Service (QoS) for individual services. The methods include collecting energy-related information (for example, energy availability, and energy source type (renewable and non-renewable)) to analyze energy usage at service/UE granularity, and adjusting QoS for individual services in a network based on the collected energy-related information. The methods include a dedicated Energy Management Function (EMF) to coordinate UE/service requirements and energy information (for example, energy usage) for energy-aware network decisions.

### TECHNICAL FIELD

Embodiments disclosed herein relate to wireless communication networks, and more particularly to providing an energy-aware service delivery in wireless communication networks by adjusting Quality of Service (QoS) for individual services.

### BACKGROUND

Rising demand for communication services is resulting in continued increase in energy consumption in wireless communication networks. Exposure of energy-related information (for example, energy consumption and energy source (renewable or non-renewable)) to verticals and users is being considered in recent releases of 3GPP 5G standards. Even though networks can utilize energy-related information to support energy-aware services, exposure of energy-related information to users and the consent of users for energy-aware service delivery may be required as it may result in dynamic adjustment to Quality of Service (QoS), leading even to a denial of service.

In an example scenario, where energy-aware QoS adjustment for services can be applied, consider that a user is watching a video over a wireless communication network. To reduce energy usage (consumption) in service delivery, a service provider reduces the quality of service from high-definition video to a standard-definition video. The resultant decrease in the data rate reduces the energy consumption in the network and saves energy. However, QoS adjustment cannot be performed on all types of services. For example, a voice call may get interrupted due to QoS adjustment. Therefore, the network has a configurable range of acceptable QoS requirements for energy-aware services.

Another example of energy-aware service delivery is prioritization of renewable energy source-operated network resources over conventional energy-operated network resources while providing a service. For example, a user can be given a service via a wireless LAN access point (say, operated by renewable energy) instead of a 5G New Radio base station (say, operated by conventional energy). However, if the renewable energy is unavailable, and is provided only when renewable energy is available, the service may be denied to the user. In another example of limited energy availability scenarios, QoS can be adjusted to enable service delivery with limited energy.

Hence, there is a need in the art for solutions which will overcome the above mentioned drawback(s), among others.

### OBJECTS

The principal object of embodiments herein is to disclose methods and systems for providing an energy-aware service delivery in wireless communication networks by adjusting Quality of Service (QoS) for individual services.

Another object of embodiments herein is to disclose methods and systems for collecting energy-related information (for example, energy availability, and energy source type (renewable and non-renewable)) to analyze energy usage at service/UE granularity, and adjusting QoS for individual services in the network based on the collected energy-related information.

Another object of embodiments herein is to disclose a dedicated Energy Management Function (EMF) to coordinate UE/service requirements and energy information (for example, energy usage) for energy-aware network decisions.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a block diagram of a system for providing an energy-aware service delivery in a wireless communication network, according to embodiments as disclosed herein;

FIG. 2 depicts a method for providing an energy-aware service delivery by the network, according to embodiments as disclosed herein;

FIG. 3 depicts a block diagram of energy monitoring with granularity, according to embodiments as disclosed herein;

FIG. 4 depicts a block diagram of dynamic service adjustment support in the network based on energy information, according to embodiments as disclosed herein;

FIG. 5 depicts an example block diagram for classifying energy-aware services, according to embodiments as disclosed herein;

FIG. 6 depicts an architectural level solution for energy-aware coordination in the network, according to embodiments as disclosed herein; and

FIG. 7 depicts a method for collecting energy related information, and analyzing/monitoring using the EMF module and QoS update for energy-aware services in the network, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

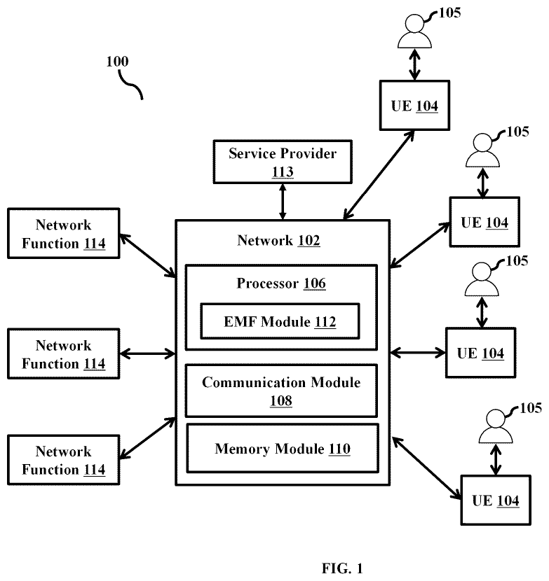

The embodiments herein provide methods and systems for providing an energy-aware service QoS based adjustments in a wireless communication network. Referring now to the drawings, and more particularly to FIGS. 1 through 7, where similar reference characters denote corresponding features consistently throughout the figures, there are shown embodiments.

FIG. 1 depicts a block diagram of a system 100 for providing an energy-aware service delivery to at least one User Equipment (UE) in a wireless communication network. The system 100 comprises a network 102, one or more User Equipment (UEs) 104, for example, UE1, UE2, . . . UEn, and one or more users 105 operating the UEs 104, for example, user1, user2, . . . usern. The UEs 104 can communicate energy-aware service information with the network 102. The network 102 further comprises a processor 106, a communication module 108, and a memory module 110. The processor 106 further comprises an Energy Management Function (EMF) module 112.

In an embodiment herein, the network 102 can communicate with at least one service provider 113 or an application service provider 113 for obtaining performance parameters for energy aware services. In an embodiment herein, the network 102 can communicate with one or more Network Functions (NFs) 114, for example, NF1, NF2, . . . NFn, to obtain energy-aware service information. The NF 114 can include, but not limited to, User Plane Functions (UPFs), Policy Control Functions (PCFs), Session Management Functions (SMFs), and so on.

In an embodiment herein, the EMF module 112 can receive one or more performance parameters for one or more energy aware services from at least one service provider 113 and at least one UE 104. In an embodiment herein, the EMF module 112 can receive a user consent from at least one UE 104 on the energy-aware services, once the user subscribes for energy-aware services.

In an embodiment herein, the EMF module 112 can collect an energy usage information, and at least one energy source data corresponding to at least one service delivery to at least one UE 104, based on the received user consent. The energy usage information, and the energy source data are collected from other network functions 114 to analyze UE/service (flow) level energy information. The energy usage information can include, but not limited to, a dynamic energy usage of one or more services, an energy usage limit of the UE 104, and one or more energy usage limits of the services. The energy usage limits can be in terms of Watts, like “5 Watts”, “2 Watts”, or can also be expressed in Kilowatt hours, for example, “0.005 kilowatt-hour”. The energy usage information can be monitored by the network 102 at a granular level. The granular level is at least one of a UE level, and a service level. The energy source data can include, but not limited to an energy source type, and an availability of at least one energy source. In an embodiment herein, the energy source data comprises a ratio of each energy source type used by the at least one NF 114 to deliver at least one energy-aware service to at least one UE 104.

In an embodiment herein, the energy usage information can be periodically collected from an Operations, Administration and Maintenance (OAM), and/or at least one Network Function (NF) 114. In an embodiment herein, the energy usage information can be collected from the OAM, and/or at least one NF 114 on at least one pre-defined event occurring. In an embodiment herein, the energy usage information can be collected from the OAM, and/or at least one NF 114 on receiving a request from the EMF module 112. In an embodiment herein, the EMF module 112 can initiate the collection of the energy usage information and the energy source data, based on an energy-aware request received from at least one service provider 113 or application service provider 113.

In an embodiment herein, the EMF module 112 can provide at least one service performance parameter of one or more energy-aware services that is being delivered to at least one UE 104, based on the collected energy usage information, and at least one energy source data corresponding to at least one service delivery. Each energy-aware service can include, but not limited to an energy usage level, an energy source data, and associated service performance parameters for at least one service. The energy usage level is a total amount of energy consumed by one or more NFs 114 to deliver at least one service to at least one UE 104. For example, the energy-aware services are displayed as one or more options on a user interface of the UE 104. This enables the user 105 of the UE 104 to select at least one energy-aware service based on user's requirement. The EMF module 112 can support the QoS profile of the service derived from a service performance parameter information acquired from at least one application service provider 113 or service provider 113 and/or UE 104.

In an embodiment herein, the EMF module 112 can receive a user consent on the energy-aware services from at least one UE 104. For example, the user consent is a user response on selection of at least one energy-aware service.

In an embodiment herein, the EMF module 112 can adjust the service performance parameter of at least one energy-aware service provided to the UE 104, based on at least one of the collected energy usage information, and the energy source data corresponding to at least one service delivery to the UE 104. The service performance parameter comprises one or more QoS profiles. Each QoS profile includes, but not limited to a required minimum date rate, a packet delay budget, and an allowed packet loss rate. The EMF module 112 can adjust at least one QoS profile for adjusting the service performance parameter of the energy-aware service. In an embodiment herein, the EMF module 112 can select a different QoS profile for adjusting the service performance parameter of the energy-aware service. For example, the user 105 can adjust at least one of the date rate, packet delay budget, and packet loss rate of the energy-aware service. This leads to the adjustment of the service performance parameter of the energy-aware service.

In an embodiment herein, each energy-aware service comprises at least one of an energy usage level, an energy source data, and associated service performance parameters for at least one service. The energy usage level is a total amount of energy consumed by one or more NFs 114 to deliver at least one service to the UE. The network 102 supports the QoS profile of the service derived from a service performance parameter information acquired from at least one application service provider 113 and/or UE 104.

In an embodiment herein, the processor 106 can process and execute data of a plurality of modules of the network 102. The processor 106 can be configured to execute instructions stored in the memory module 110. The processor 106 may comprise one or more of microprocessors, circuits, and other hardware configured for processing. The processor 106 can be at least one of a single processer, a plurality of processors, multiple homogeneous or heterogeneous cores, multiple Central Processing Units (CPUs) of different kinds, microcontrollers, special media, and other accelerators. The processor 106 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 106 of the network 102 can communicate via the communication module 108. The EMF module 112 of the processor 106 can be in connection with the communication module 108, and can communicate via the communication module 108. The communication module 108 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 110 may comprise one or more volatile and non-volatile memory components which are capable of storing data and instructions of the modules of the network 102 to be executed. The memory module 110 can be in communication with the EMF module 112 of the processor 106. Examples of the memory module 110 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 110 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 110 may, in some examples, be considered a non-transitory storage medium. The term “non-transitory” may indicate that the storage medium is not embodied in a carrier wave or a propagated signal. However, the term “non-transitory” should not be interpreted to mean that the memory module 110 is non-movable. In certain examples, a non-transitory storage medium may store data that can, over time, change (for example, in Random Access Memory (RAM) or cache).

FIG. 1 shows example modules of the network 102, but it is to be understood that other embodiments are not limited thereon. In other embodiments, the network 102 may include less or more number of modules. Further, the labels or names of the modules are used only for illustrative purpose and does not limit the scope of the invention. One or more modules can be combined together to perform same or substantially similar function in the network 102.

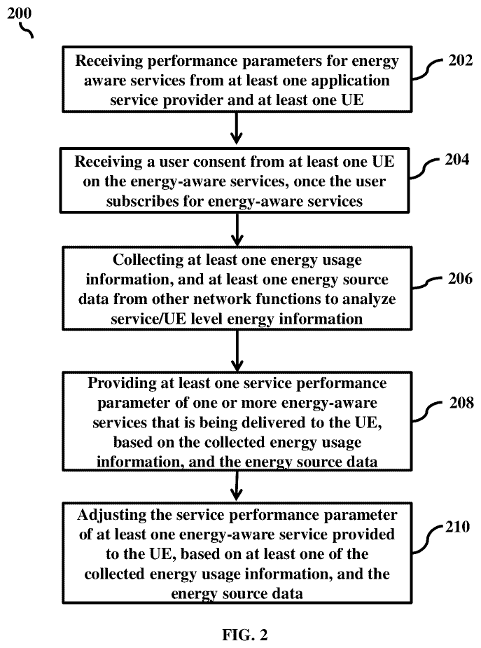

FIG. 2 depicts a method 200 for providing an energy-aware service delivery to at least one UE 104 by the network 102. The method 200 comprises receiving one or more performance parameters for one or more energy aware services from at least one service provider 113 and at least one UE 104, as depicted in step 202. The method 200 comprises receiving a user consent from at least one UE on the energy-aware services, once the user subscribes for energy aware services, as depicted in step 204.

The method 200 comprises collecting at least one energy usage information, and at least one energy source data corresponding to at least one service delivery to at least one UE 104, as depicted in step 206 based on the user consent. The energy usage information, and the energy source data are collected from other network functions to analyze UE/service (flow) level energy information. The method 200 comprises providing at least one service performance parameter of one or more energy-aware services that is being delivered to the UE 104, based on the collected energy usage information, and the energy source data, as depicted in step 208.

Thereafter, the method 200 comprises adjusting the service performance parameter of at least one energy-aware service provided to the UE 104, based on at least one of the collected energy usage information, and the energy source data, as depicted in step 210.

The various actions in method 200 may be performed in the order presented, in a different order or simultaneously. Further, in some embodiments, some actions listed in FIG. 2 may be omitted.

### Energy Awareness in the Network

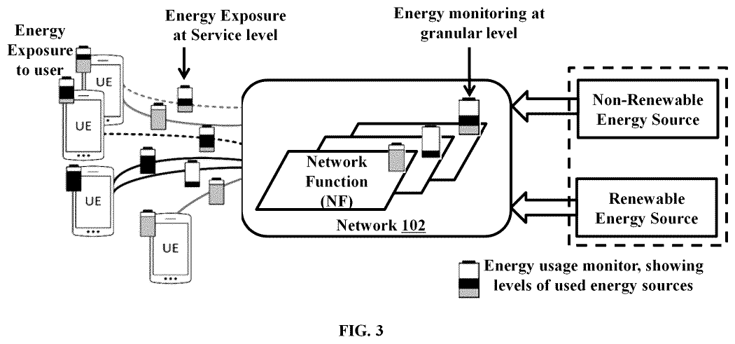

To facilitate energy-aware service delivery, support for energy consumption monitoring at a granular level, i.e., per service (flow), per UE along with the ability to identify energy source(s) used (including information on renewable and non-renewable energy sources used along with their ratio in the mix) in the network 102 is proposed, which is illustrated in FIG. 3. FIG. 3 depicts a block diagram of energy monitoring with granularity. Once collected (through OAM and/or at least one NF 114), the network 102 can provide service-level energy usage exposure to users 105, including information on energy sources. The energy usage exposure facilitates provisioning of energy-aware services in the network 102 based on user choice.

### QoS Adjustment Based on Energy Information in the Network

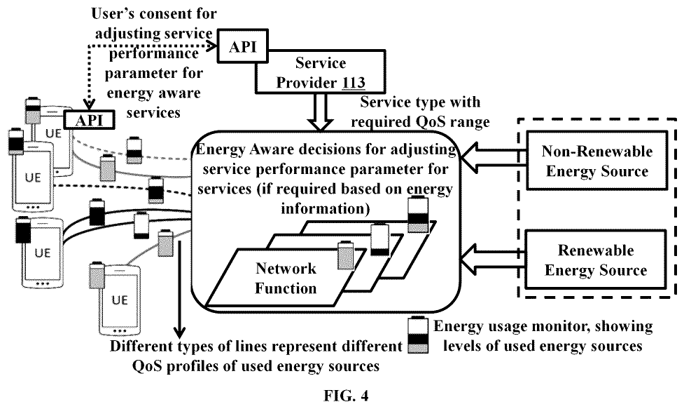

The network 102 contains information about the QoS on individual service flows. Using the service provider 113/Network Exposure Function (NEF) interface for “Nnef_AFsessionWithQoS service” or Non-Access Stratum (NAS) level Packet Data Unit (PDU) session related messages from the UE 104, the network 102 can acquire the QoS-related information for individual service flows (QoS rules, QoS flow descriptions). The service provider 113 can provide alternative service requirements for each service (flow) containing QoS profiles in a prioritized order to be selected dynamically by the network 102. Based on inputs received from the UE 104 (regarding user's consent on QoS adjustment), and the energy information collected from the network functions 114, energy-aware policy decisions can be taken to dynamically adjust one or more QoS profiles for services (flows) or to select a different QoS profile for adjusting the service performance parameter of the energy-aware service, as shown in FIG. 4. FIG. 4 depicts a block diagram of dynamic service adjustment support in the network 102 based on energy information.

Few example scenarios to trigger QoS adjustments are dynamic availability of renewable energy sources, energy usage limit of the user 105, and energy usage limits of resources. For example, if there is a limited energy availability due to a renewable energy source (as they depend on natural resources which have dynamic characteristics due to multiple factors such as weather changes), QoS of services can be reduced to save energy.

### Classification of Energy-Aware Services

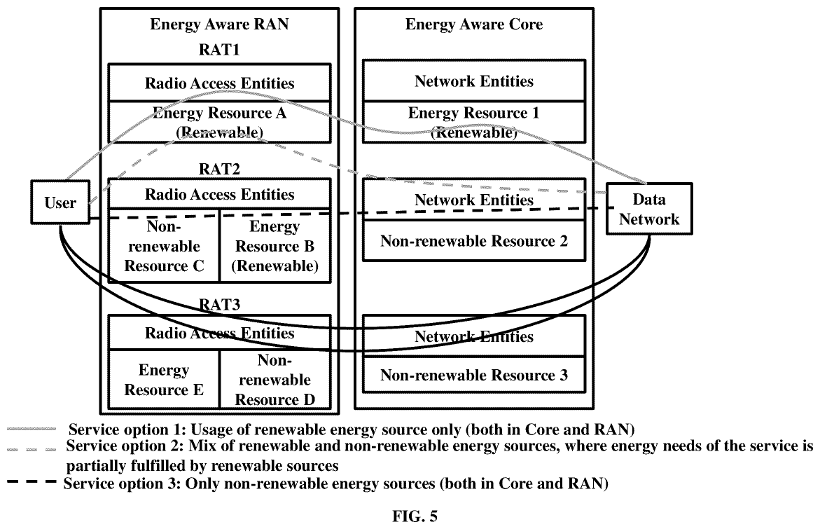

The users/verticals can be facilitated with a choice to select an option from available energy-aware services as shown in FIG. 5. FIG. 5 depicts an example block diagram for classifying energy-aware services. As depicted, service option 1 indicates usage of renewable energy source only (both in Core and RAN), service option 2 indicates mix of renewable and non-renewable energy sources, where energy needs of the service is partially fulfilled by renewable sources, and service option 3 indicates Service option 3: Only non-renewable energy sources (both in Core and RAN). For example, an environment-friendly user 105 chooses a service option 1 (using renewable energy source only) over a service option 3 (using non-renewable energy source only). A user can also be indicated to specify the energy usage limit at UE/service level, for example, energy usage lower than 4 Watts.

Feasibility of service subscriptions for users 105 with multiple levels of energy and QoS mapping can introduce openness in energy-based network exposure. QoS comprises of following profiles, such as, bit rate, packet delay budget, and packet loss ratio. A scheme can be used to convert these QoS values into QoS profiles, and further can be directly mapped with energy consumption. For example, high data rate can lead to more energy usage in the network as compared to a low data rate. The inclusion of energy consumption as a performance criterion like bit rate, and latency is the first step towards designing energy-aware service and subscriptions.

### Energy Management Function

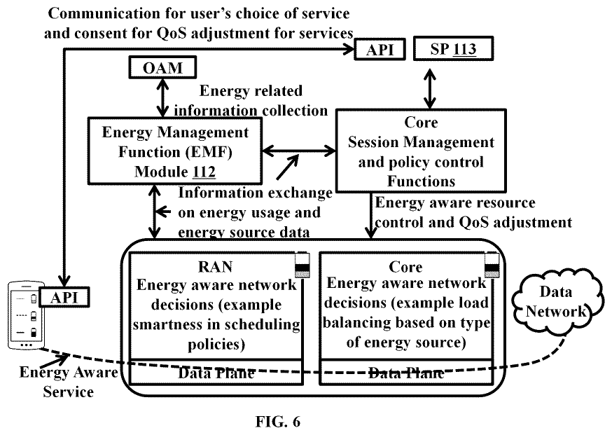

A dedicated Energy Management Function (EMF) 112 is introduced to coordinate service requirements and the selection of network functions 114 based on energy information (for example energy usage, energy credits, and so on) for providing energy-aware services, as depicted in FIG. 6. FIG. 6 depicts an architectural level solution for energy-aware coordination in the network 102.

The EMF module 112 collects granular-level energy information from an OAM, and other real time information from all network functions 114 to analyze and monitor energy parameters at granular level (per UE/per service). Service Provider (SP) 113 shares service requirements with Policy Control Function (PCF) during service setup. The EMF module 112 also interacts with Session Management Functions (SMF) in the core, and provides information regarding service (flow)-wise energy information. SMFs can utilize this information for energy-aware resource allocation which further may need adjustments in QoS at flow level.

The energy information exposure within the network 102 can drive energy-aware decisions in a Radio Access Network (RAN) and core, and these decisions at various levels adjust policies and QoS per service for underlying resources. One example of energy-aware decision is energy-aware smart scheduling in RAN which can apply changes in end-to-end delay to achieve higher energy efficiency. If the delay budget for a user 105 is increased, then the base station has greater flexibility in scheduling the user 105 and the base station can decide to schedule the user 105 when the radio condition is better for data transfer to that user 105, meaning more energy efficiency can be achieved. Increased buffering capacity may also help in energy efficient operation, allowing for energy efficient scheduling (when the radio condition is better for data delivery). Another example is energy-aware load balancing related decisions in the core. The core can prioritize using renewable energy source operated resources for managing maximum possible load. The EMF module 112 also maps energy information at the service level along with associated QoS, and this mapping can be exposed to SP 113 as per their choices. Overall, the dedicated EMF module 112 for managing energy related information and coordinating energy related communication is a must for a feasible energy-aware network.

### Energy Information Collection, Analysis and QoS Adjustment for Energy-Aware Services Using EMF

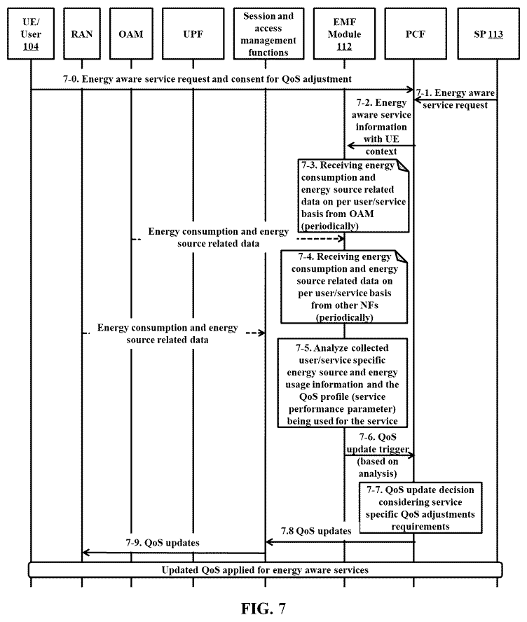

A method 700 for collecting energy related information and analyzing/monitoring using the EMF module 112 and QoS update for energy-aware services in the network 102 is shown in FIG. 7. An energy aware service request, and consent for QoS adjustment is sent from the UE 104 to the PCF, as depicted in step 7-0. Thereafter, Service Provider (SP) 113 sends an energy-aware service request to the PCF, as depicted in step 7-1. The PCF informs the EMF module 112 about the energy-aware service request along with UE context, as depicted in step 7-2, as the EMF module 112 performs energy related data collection and analysis to monitor energy usage parameters per UE/service.

To correlate and analyze information on UE/service level, the EMF module 112 periodically collects energy consumption and energy source related data on per user/service basis from the OAM, and at least one NF 114, as depicted in step 7-3. The EMF module 112 also periodically receives energy consumption and energy source related data on per user/service basis from other NFs 114, as depicted in step 7-4. For example, other energy usage information, channel related real time information can be collected from RAN. UPFs can provide usage related information about core data plane as there can be more than one UPF in the path. Although UPF does not provide this information to the EMF module 112 directly, the UPF provides this information through SMF to the EMF module 112. The EMF module 112 is not aware of which UPFs are being used in the path. The EMF module 112 collected user/service specific energy source and energy usage information and the QoS profile (service performance parameter) being used for the service, as depicted in step 7-5.

Based on this analysis and monitoring, the EMF module 112 can trigger QoS adjustment to the PCF if needed, as depicted in step 7-6. The PCF takes decision for updating QoS considering service specific QoS adjustment requirements, as depicted in step 7-7. The PCF sends the QoS update decision to SMF, as depicted in step 7-8, which further applies QoS updates in core and RAN data planes accordingly, as depicted in step 7-9.

The various actions in method 700 may be performed in the order presented, in a different order or simultaneously. Further, in some embodiments, some actions listed in FIG. 7 may be omitted.

Therefore, the energy-aware QoS based adjustments can result in overall energy saving in the network 102. Three main QoS profiles such as a required minimum date rate, latency (packet delay budget), and an allowed packet loss rate can play a role in increasing energy efficiency. For example, greater tolerance for packet loss can result in more energy efficient operation as the packets (HARQ and RLC level ARQ) are not needed to resend in case of packet loss (or the number of repetitions can be reduced), and this may make the operation energy efficient.

Further, integration of such energy-saving solutions at all levels in future networks design, and exposure of energy-related information to verticals and users 105 is essential for minimizing energy usage in future networks. The methods 200 can encourage lower energy consumption and increased utilization of renewable energy.

The proposed method 200 supports energy-aware service delivery in wireless communication networks, for example, in 5G and beyond networks. The energy-aware service delivery reduces energy consumption and usage of renewable energy, to reduce the adverse effects of wireless communication networks on climate change and global energy availability. The coordinated solution between users 105 and the network 102 reduces energy consumption in wireless communication networks, and prioritizes the usage of renewable energy therein.

The embodiments disclosed herein can be implemented through at least one software program running on at least one hardware device and performing network management functions to control the network elements. The elements include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

We claim:

1. A method for providing an energy-aware service delivery to at least one User Equipment (UE) in a wireless communication network, comprising:
collecting, by the network, at least one energy usage information, and at least one energy source data corresponding to at least one service delivery to at least one UE;
providing, by the network, at least one service performance parameter of one or more energy-aware services being delivered to the at least one UE, based on the collected at least one energy usage information, and the at least one energy source data; and adjusting, by the network, the at least one service performance parameter of the at least one energy-aware service provided to the at least one UE, based on at least one of the collected at least one energy usage information, and the at least one energy source data.

2. The method as claimed in claim 1, wherein the at least one energy usage information is collected from at least one of an Operations, Administration and Maintenance (OAM), and at least one Network Function (NF), wherein the at least one energy usage information is monitored by the network at a granular level, wherein the granular level is at least one of a UE level, and a service level, wherein the network receives a user consent from the at least one UE on the one or more energy-aware services before provisioning at least one energy-aware service to that at least one UE operated by at least one user.

3. The method as claimed in claim 1, wherein the at least one energy usage information comprises at least one of a dynamic energy usage of the one or more services, an energy usage limit of the at least one UE (104), and one or more energy usage limits of the one or more services.

4. The method as claimed in claim 1, wherein the at least one energy source data comprises at least one of an energy source type, and an availability of the energy source.

5. The method as claimed in claim 1, wherein the at least one service performance parameter comprises one or more Quality of Service (QoS) profiles, wherein each QoS profile comprises at least one of a required minimum date rate, a packet delay budget, and an allowed packet loss rate.

6. The method as claimed in claim 1, wherein the method of adjusting the at least one service performance parameter of the at least one energy-aware service comprises at least one of adjusting at least one QoS profile, and selecting a different QoS profile.

7. The method as claimed in claim 5, wherein the network supports the at least one QoS profile of the at least one service derived from a service performance parameter information acquired from at least one of an application service provider, and a UE.

8. A network, comprising:
a processor;
a memory module, and
wherein the processor is coupled with the memory module, and configured to:
collect at least one energy usage information, and at least one energy source data corresponding to at least one service delivery to at least one User Equipment (UE) operated by at least one user;
provide at least one service performance parameter of one or more energy-aware services being delivered to the at least one UE, based on the collected at least one energy usage information, and the at least one energy source data; and
adjust the at least one service performance parameter of the at least one energy-aware service provided to the at least one UE, based on at least one of the collected at least one energy usage information, and the at least one energy source data.

9. The network as claimed in claim 8, wherein the at least one energy usage information is collected from at least one of an Operations, Administration and Maintenance (OAM), and at least one Network Function (NF), wherein the at least one energy usage information is monitored by the processor at a granular level, wherein the granular level is at least one of a UE level, and a service level, wherein the network receives a user consent from the at least one UE on the one or more energy-aware services before provisioning at least one energy-aware service to that at least one UE operated by at least one user.

10. The network as claimed in claim 8, wherein the at least one energy usage information comprises at least one of a dynamic energy usage of the one or more services, an energy usage limit of the at least one UE, and one or more energy usage limits of the one or more services.

11. The network as claimed in claim 8, wherein the at least one energy source data comprises at least one of an energy source type, and an availability of at least one energy source.

12. The network as claimed in claim 8, wherein the at least one service performance parameter comprises one or more Quality of Service (QoS) profiles, wherein each QoS profile comprises at least one of a required minimum date rate, a packet delay budget, and an allowed packet loss rate.

13. The network as claimed in claim 8, wherein the processor is configured to perform at least one of adjusting at least one QoS profile, and selecting a different QoS profile for adjusting the at least one service performance parameter of the at least one energy-aware service.

14. The network as claimed in claim 8, wherein the network supports the at least one QoS profile of the at least one service derived from a service performance parameter information acquired from at least one of an application service provider, and a UE.
